(19) United States
(12) Patent Application Publication
(10) Pub. No.: US 2003/0020992 A1
(43) Pub. Date: Jan. 30, 2003

(54) Free space optical communication network and stations thereof

(76) Inventor: Joseph Child, Alexandria, VA (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/088,559

(22) PCT Filed: Jul. 19, 2001
(86) PCT No.: PCT/US01/22512

(30) Foreign Application Priority Data
Jul. 19, 2000 (US) 60219127
Jul. 26, 2000 (US) 60220843
Mar. 26, 2001 (US) 60278476

(51) Int. Cl. H04J 14/08; H04B 10/00

(52) U.S. Cl. 359/172; 359/159

(57) ABSTRACT

A free space optical communication network includes plural stations, some capable of functioning as both transceivers and repeaters, and to a station having such capability. The stations include a transmitter array having many optical emitter elements, each having an associated beam and a receiver having a receiver array with many optical detector element areas having beams corresponding with the beam of an emitter element of a transmitting optical station of the network. An optical arrangement associated with the arrays and the arrays themselves are such that beams associated with different elements of each array can be coupled with different stations of the network. The stations include one or more of the following features: (1) overlapping beams, (2) avalanche photodiodes in the receive array, (3) a filter arrangement for enabling only a desired wavelength to be transmitted from and received by the arrays, and (4) transmit and receive arrays at different locations in the stations so that photons emitted from the transmit array do not interfere with detectors of the receive array.

### CROSS-REFERENCE TO RELATED APPLICATIONS

This application is an improvement on U.S. patent application Ser. No. 09/608,610, filed Jun. 30, 2000, entitled Free Fixed and Mobile Optical Communication System, corresponding with PCT/US00/18147, filed Jul. 1, 2000, both having priority based on the U.S. Provisional Application Ser. No. 60/141,861, filed Jul. 1, 1999. This application is also a continuation in part of U.S. Provisional Applications Ser. No. 60/219,127, filed Jul. 19, 2000; Ser. No. 60/220,843, filed Jul. 26, 2000; and Ser. No. 60/278,476, filed Mar. 26, 2001.

### FIELD OF INVENTION

The present invention relates generally to free space optical communications and more particularly to a free space optical communication network including plural stations, at least some of which are capable of functioning as both transceivers and repeaters, and to a station having such capability. A further aspect of the invention relates to an optical station for use in a free space optical communication network including a transmitter with a transmitter array having many optical emitter elements, each having an associated beam and a receiver having a receiver array with many optical detector element areas having beams corresponding with the beam of an emitter element of a transmitting optical station of the network, wherein an optical arrangement associated with the receive and transmit arrays and the arrays are such that beams associated with different elements of each array can be coupled with different stations of the network, in combination with one or more of the following features: (1) overlapping beams, (2) avalanche photodiodes in the receive array, (3) a filter arrangement for enabling only a desired wavelength to be transmitted from and received by the arrays, and (4) transmit and receive arrays at different locations in the stations so that photons emitted from the transmit array do not interfere with detectors of the receive array.

### BACKGROUND OF THE INVENTION

The demand for higher data rates in telecommunications is growing rapidly. Future demands for data transmission cannot be met with existing or anticipated systems. The capacity of high speed computers will remain largely unexplored unless transmission facilities become available for supporting much higher data rates than are currently available. Fiber optic transmission systems were perceived as an answer to the problem. However, after decades of fiber optic line deployment, approximately only 5 percent of the largest three-quarters of a million commercial buildings in the United States have fiber optic lines passing them. Most commercial buildings do not and may never have taps into fiber lines for numerous reasons related to construction efforts required to connect the buildings to the fiber optic lines.

Free space optical communications is rapidly being accepted in the telecommunications industry as a suitable technology for local connections between telecommunication networks and network users, particularly for broadband services. The cost of free space optical links is relatively high, however. A major cost of free space optical links is the electromechanical parts that keep narrow optical beams aligned over the free space link.

The system described in my published PCT application, PCT/US00/18147, corresponding with WO 01/03241 A1 contains multiple stations and arrays of detectors and emitters for sending and receiving free space optical signals. Each array contains transmit (i.e., emitter) and receive (i.e., detector) elements positioned at a focal surface of an optical antenna so that one array contains both receiver and transmitter elements. Feasibility studies, however, indicate that it may be undesirable for the transmit and receive elements to be positioned at the same focal surface of the same optical antenna.

Optical, i.e., photonic, detectors are typically sensitive to optical energy across a wide range of wavelengths, i.e., frequencies. Energy entering a station and reaching detectors of a receive array of the station can cause interference with desired received optical signals. Furthermore, if sufficient solar energy is incident on detectors of a receive array or emitters of a transmit array, damage to the detectors or emitters can occur. In particular, the undesired energy can cause heating of the detectors and emitters, resulting in thermal damage to them. Typically, in the prior art, the transmitted and received beams of an optical free space communication network have been relatively narrow spot beams, typically milliradians in diameter. These very narrow beams, however, require very precise alignment between corresponding emitter and detector elements of the transmit and receive arrays. If, however, there are atmospheric disturbances or perturbations in the communication link and/or a building including a transmit or receive array sways, as frequently occurs, the transmit and receive beams deviate from the desired path, causing signal failure. In the past, the perception has been that it is necessary to use very narrow beam widths because receive arrays have employed low sensitivity detectors.

Typical prior art free space optical communication networks have employed point to point links, with a single free space optical link being provided between each transmit and receive array. However, there are frequently disturbances in the link which cause transient and/or permanent disabling of the link. A further problem with the prior art networks is that they do accommodate an inoperative emitter in a transmit array and/or an inoperative detector in a receive array. The emitters and detectors of the arrays have a tendency to fail during operation as well as a tendency, when the array is initially manufactured, to be inoperative. The prior art free space optical communication networks also are characterized by dedicated transceiver stations and dedicated repeater stations. It has now been realized that such dedicated stations are unnecessarily expensive.

### SUMMARY OF THE INVENTION

According to one aspect of the invention, a communication network comprises a plurality of optical stations adapted to be coupled to each other by free space optical links. A first of the optical stations is a base station adapted to do to be coupled to (a) stations other than the optical stations, e.g., to the Internet, or a conventional telephone system, and (b) at least one of the plural optical stations. Each of the plural optical stations has an identification, e.g., an address, and is arranged to couple optical messages to others of the optical stations via the optical links. Each of the messages includes a data portion and an identifier for a destination station of the message, e.g., the destination station address. Each of the optical stations is arranged for (a) determining if the destination station identifier in a message matches the identification of the optical station receiving the message, and (b) responding to the data portion of the message in response to the identifier being the identification of that particular station. Others of the optical stations are arranged for (a) determining if the destination station identifier in a message matches the identification of the optical station receiving the message, (b) responding to the data portion of the message in response to the identifier being the identification for that particular station, and (c) relaying the message toward the destination station in response to the identifier being different from the identification for that particular station.

Another aspect of the invention relates to an optical station for use in a communication network having a plurality of the optical stations that are adapted to be coupled to each other by free space optical links. Each of the plural optical stations has an identifier. The optical station comprises a receiver of free space optical energy messages and an emitter of free space optical energy messages. Each of the messages includes a data portion and an identifier for a destination station of the message. The optical station is arranged for (a) determining if the destination station identifier in a message matches the identification of the optical station, (b) responding to the data portion of the message in response to the identifier being the identification for the station, and (c) relaying the message toward the destination station in response to the identifier being different from the identification for the station.

The messages are preferably arranged in packets, each including overhead bits indicating a packet type and the destination station identifier. The overhead bits can also indicate (a) the identification of the optical station originating the message, and (b) the type of station emitting the message.

At least one of the plural optical stations can be a relay station for (a) detecting the destination station identifier in messages that the relay station receives, and (b) relaying the message toward the destination station in response to the detected identifier. The relay station is incapable of responding to the data portion of the message. The plural optical stations arranged for performing (a), (b) and (c) are end user stations, some of which are mobile.

Each of the optical stations is preferably arranged for transmitting each message on a monochromatic carrier having a particular wavelength. Each of the optical stations preferably includes a receive array associated with a filter arrangement for passing the wavelength to detectors of the receive array and preventing other wavelengths from substantially affecting the detectors of the receive array. Each of the optical stations also preferably includes a transmit array associated with a filter arrangement for (a) passing the wavelength to free space from emitters of the transmit array and (b) preventing other wavelengths from substantially affecting the emitters of the transmit array.

Preferably, each of the optical stations includes a transmit array and a receive array. The transmit and receive arrays of a particular optical station are at different locations so that photons emitted from the transmit array at the particular optical station do not interfere with detectors of the receive array at the particular optical station.

The transmit and receive arrays at any particular optical station are preferably associated with plural beams. Some of the plural beams of one optical station are arranged to be coupled with more than one of the other optical stations of the network. Preferably, at least two of the plural beams of one optical station that are arranged to be coupled with more than one of the optical stations have overlapping portions when incident on detectors in a receiver array of an optical station coupled via one of the optical links with the optical station transmitting the overlapping beams.

The optical stations can be arranged so there are plural optical links among the optical stations. Each of the plural optical links between some of the optical stations can include different intermediate optical stations for relaying messages from an originating optical station to a designated destination optical station.

The optical stations are preferably arranged, (e.g., spaced from each other) so each beam incident on a receiving optical station includes parallel rays. Each optical station preferably includes (a) an array of optical detectors arranged in detector areas and (b) an optical element for focusing each beam incident on one detector area of the receiving optical station. Each optical station also preferably includes a transmit array of optical emitters for emitting optical beams, and an optical element for causing each emitted beam to diverge slightly as it travels through free space. The emitters and optical arrangement are arranged so that beams derived from different emitters of the same emitting array can propagate to different optical receiving stations.

Because of the diverging beams, each optical station preferably includes a receive array having many avalanche photodiodes, which have photon sensitivity an order of magnitude greater than conventional silicon photodiodes.

Each optical station also preferably includes a transmit array including many optical emitters each having an associated beam and a receive array including many optical detector areas each having an associated beam. The beam of a detector area of a receiving optical station preferably corresponds with the beam of an emitter of transmitting optical station.

Other aspects of the invention have as a common feature an optical station for use in a communication network having a plurality of optical stations. The optical stations are adapted to be coupled to each other by free space optical links. The optical station comprises a receiver of free space optical energy messages and a transmitter of free space optical energy messages. The receiver includes a receive array having many optical detector element areas each having an associated beam. The transmitter includes a transmit array including many optical emitter elements each having an associated beam. The beam of a detector area corresponds with the beam of an emitter element of an originating optical station of the network. An optical arrangement is associated with the receive and transmit arrays. The optical arrangement and the arrays are such that beams associated with different elements of each array can be coupled with different stations of the network or can overlap when coupled with different stations of the network. Another feature that can be combined with the common feature is that the receive array can include many avalanche photodiodes.

A further feature that can be combined with the common feature is that the optical emitter elements emit a monochromatic carrier having a particular wavelength. The receive array is associated with a filter arrangement for (1) passing the wavelength to detectors of the receive array and (2) preventing other wavelengths from substantially affecting the detectors of the receive array. In addition, the transmit array can be associated with a filter arrangement for (1) passing the wavelength to free space from the emitters of the transmit array and (2) preventing other wavelengths from substantially as affecting the emitters of the transmit array.

An added feature that can be combined with the common feature is that the beam of a detector area corresponds with the beam of an emitter element of a transmitter optical station of the network. An optical arrangement is associated with the receive and transmit arrays. The optical arrangement and the arrays are such that beams associated with different elements of each array can be coupled with different stations. The transmit and receive arrays are at different locations so that photons emitted from the transmit array at the station do not interfere with detectors of the receive array at the station.

The above and still further objects, features and advantages of the present invention will become apparent upon consideration of the following detailed description of one specific embodiment thereof, especially when taken in conjunction with the accompanying drawings.

### BRIEF DESCRIPTION OF THE DRAWING

FIG. 1 is a diagram of an exemplary free space optical mesh communication network in accordance with an embodiment of the present invention;

FIG. 2 is a diagram of a data packet included in messages transmitted between stations of the network of FIG. 1;

FIG. 3 is a schematic diagram of a station included in the network of FIG. 1; and

FIG. 4 is a schematic diagram of a transmit array and a lens in the station of FIG. 3, wherein the transmit array emits plural beams which overlap at a station of the network of FIG. 1.

### DETAILED DESCRIPTION OF THE DRAWING

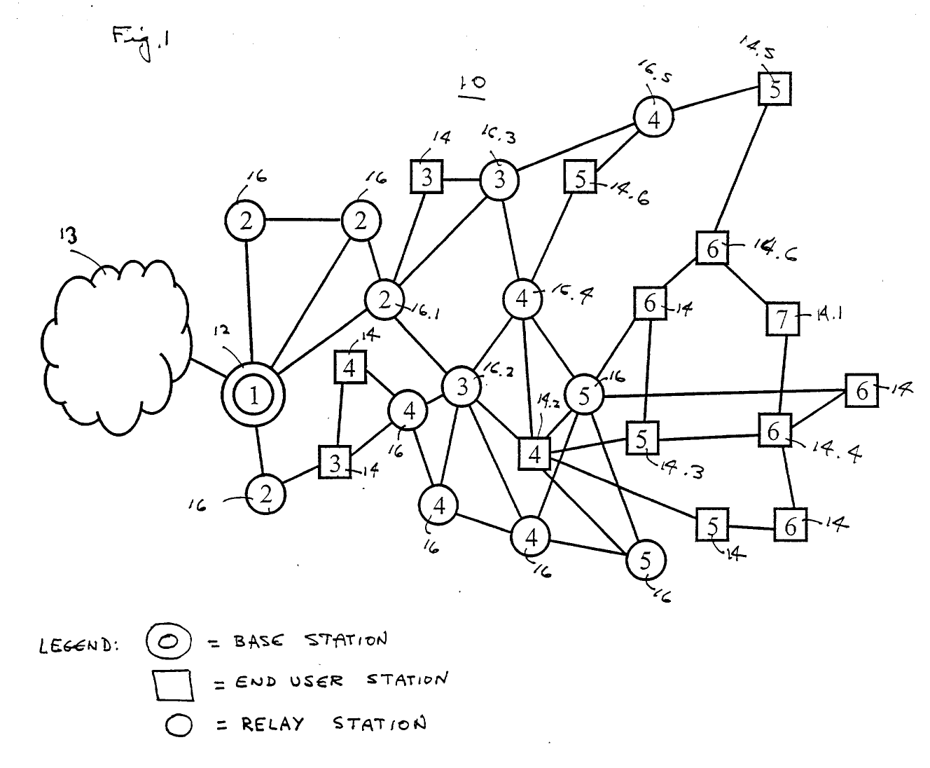

Reference is now made to the free space optical communication mesh network of FIG. 1 that includes base station 12 and other stations which communicate with each other and the base station by free space optical communication links. Base station 12, in addition to being optically coupled to the stations of network 10, is connected to stations of other networks 13 by prior art telecommunication links. The other networks 13 can, for example, include the Internet and other prior art voice, video and data networks. A geographical location, such as a city, can include several free space optical communication networks similar to network 10.

Adjacent stations of network 10 are in line of sight of at least one other station within the network 10 and spaced from each other by a distance such that optical energy transmitted from one station to another station is in beams having rays that are essentially parallel to each other within the portion of the beam received at a receive array of a receive station. The optical energy in each beam is preferably monochromatic, and can be coherent such that each link has the same wavelength. The beams transmitted from each station diverge slightly, and typically have a beam width of two to three degrees, in contrast to prior art systems which have employed beam widths typically less than one degree. The beams are emitted from a transmit array including many optical emitters and detected by a receive array including many optical detectors at each station.

Network 10, in addition to including base station 12, has several end user stations 14, some of which are fixed and some of which can be mobile; the end user stations are indicated in FIG. I as squares. Network 10 also includes relay stations 16, indicated in FIG. I by circles. Stations 12, 14 and 16 are coupled together in a hierarchical manner, with base station 12 having a hierarchy designation of 1, the relay stations 16 directly coupled to base station 12 having a hierarchy of 2, the end user and relay stations directly coupled with the relay stations of hierarchy 2 having a hierarchy of 3, etc. The hierarchies are indicated in the squares and circles designating the end user and relay stations by their position number within the hierarchy.

All of the end user stations 14 are optical transceivers, i.e., they can transmit, originate, receive and decode user data. In addition, the fixed user stations also function as repeaters, i.e., relay stations that do not originate or decode user data, thereby enabling the number of repeaters in the network that are not fixed end user stations to be substantially reduced. There are also multiple optical links to and from some stations of network 10, which is advantageous in the event of an obstruction being in one of the free space optical links between a pair of stations or in the event of a failure of the stations in the link.

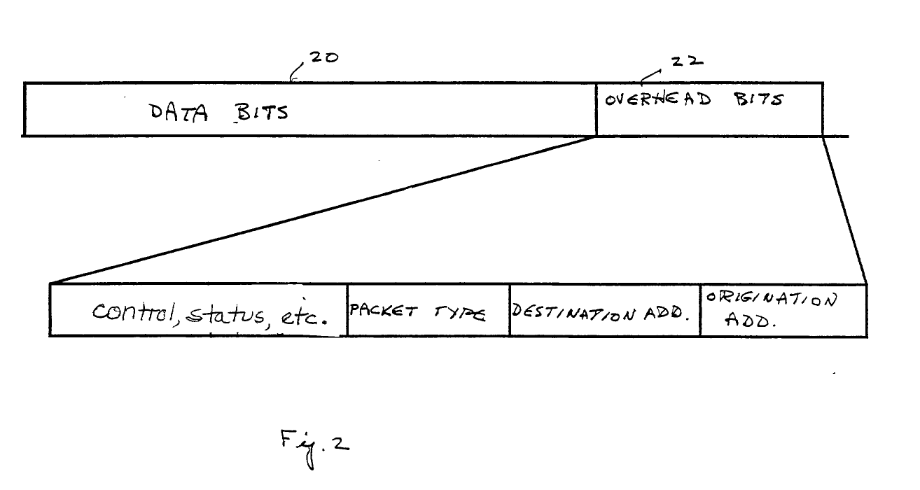

The free space optical links of network 10 carry messages between stations 12, 14 and 16. Each message is arranged as a packet, including user data portion 20, FIG. 2, and overhead bits 22, which are typically included in a header of the packet, but can be elsewhere in the packet. The number of user data bits 20 can be large and not necessarily fixed. Overhead bits 22 are divided into several different groups, representing different information important for transmitting a packet between stations in mesh network 10 and from the mesh network to other networks 13.

One group of overhead bits 22 indicates the type of packet, i.e. that the packet originated within local mesh network 10, the types of station in network 10 where the packet originated or that the packet originated from a station in network 13 external to network 10. A second group of overhead bits 22 indicates the address of the destination station, in the above example end user station 14.1. Several overhead bits are also included for the address of the station which originated the message, e.g., base station 12. Other overhead bits are allocated for control purposes, status purposes, and other system properties important in transmitting a message, including parity bits for error detection and or correction purposes.

Electronic circuitry, e.g., a microprocessor 32 including memory, included in each of the stations evaluates the information content of overhead bits to initially determine if the station itself is the destination of a received message. In response to the station detecting that it is not the destination for the message, the station transmits the entire message to another station in the network 10 with which the station shares a link. If, for example, the message is being transmitted from bas& station 12 to end user station 14.1, and the message is at relay station 16.1, relay station 16.1 determines, from the destination address of the message and instructions stored in its electronic circuitry, the next station or stations to receive the message.

Relay station 16.1 determines, from its memory, that the message for end user station 14.1 can be routed to that end user station by one or more links to station 16.1. That is, each station stores information in its memory indicative of which links to adjacent stations are to be used fOr sending the message to a particular end destination address within the network 10. One of the links may be to relay station 16.2, while the other link to relay station 16.3. Relay station 16.1 transmits the message to both relay stations 16.2 and 16.3. Relay station 16.2 responds to the message by sending station 16.1 an acknowledgement packet, and then transmits the message over the next link toward station 14.2 as determined by station 16.2 examining its memory for link information stored for station 14.1. End user station 14.2 reads the destination address overhead bits in the message and processes the message in the same way that the message is processed by a relay station, relaying the message over predetermined links toward station 14.1. End user station 14.2 may route the message to end user station 14.3. Station 14.3 transmits the message to end user station 14.4. End user station 14.4 processes the message in the same manner that the message is processed by end user stations 14.2 and 14.3. End user station 14.4 then transmits the message to end user station 14.1.

End user station 14.1 compares the destination address overhead bits in the message with destination data stored in its memory. End user station 14.1 finds that there is a match between its address and the message destination address. In response to the match being detected, end user station 14.1 electronically transfers the message to the local end user.

Network 10 includes multiple stations with different quantities of beams. A relay station may have a sufficient number of beams to have a field of regard that is 360 degrees. An end user station's field of regard may be only 45 degrees since it may be intended for communications through an office building window.

Because the beams of the transmit and receive arrays are somewhat diverging, having a beam angle that is typically two to three degrees, precise alignment of the detectors and emitters of the receive and transmit arrays is not necessary. In addition, the outgoing, i.e., transmit beams and the incoming, i.e., receive beams of each station are configured such that adjacent beams overlap, as incident on a receive array, or as transmitted from a transmit array. This provides coverage redundancy and ensures coverage at a receive array in the event of (1) an emitter of a transmit array failing or (2) link alignment between the transmit and receive arrays changes slightly as is often the case with very tall buildings swapping.

A local network 10 has a central base station 12. When a new station is introduced into the network, whether it is a mobile station or newly installed fixed station, the central base station is accessed over the network by the entering unit transmitting a message to the base station 12. Base station 12 stores in its memory a set of destination addresses for units operating within network 10. An entering station sends its unique electronic ID to the base station. The ID is unique among all the stations manufactured.

To ensure that stations in mesh network 10 are current in their knowledge of the stations connecting them with the other stations in network 10, every end user station 14 periodically transmits an outgoing “maintenance” packet to base station 12. The period between “maintenance” packets transmitted by a given station is called the “ID Period” and is a fixed duration. The “maintenance” packet has bits set in the packet's overhead bits for “packet type” 22 to indicate the packet is a “maintenance” packet. Each station that receives a “maintenance” packet determines the “packet type” and records in memory the end user source identification address and the link used to receive the packet. The packet reaches base station 12, which also records the source identification and beam or links used. The base station then abandons the packet. The source identification and link information is used subsequently to determine which link to use when sending a message to that end user station.

Each station relays the “maintenance” packet toward the base station. The information stored in the memory at each station as a result of these “maintenance” packets being relayed across the network 10 remain valid for a period between one or more “ID Periods”. The information is then erased from a station's memory. This allows stations to be continually updated as mobile stations move from one beam or station to the next. The “maintenance” packets are transmitted relatively frequently, for example, once every ten seconds by stations 14 with fixed location and once every few milliseconds by mobile stations.

Packets or messages initiated by an end user station always contains the source station's identification address. When any packet originating at an end user station passes across the network 10, the address of the source is read by each station receiving and relaying the packet. That is, all messages are used to determine user addresses and associate them with links. The “maintenance” packets serve to refresh stations when no user messages with are being transmitted.

Packets received by a station12, 14, or 16 contain a destination address for the packet. There are 3 ways a station processes the packet depending on the destination address contained in the packet The address may be the address of the station itself, or an address in the list of addresses created by “maintenance” packets or previously received messages. The third possibility is that the address is neither the station's address nor in the list it maintains. In this event the packet is abandoned.

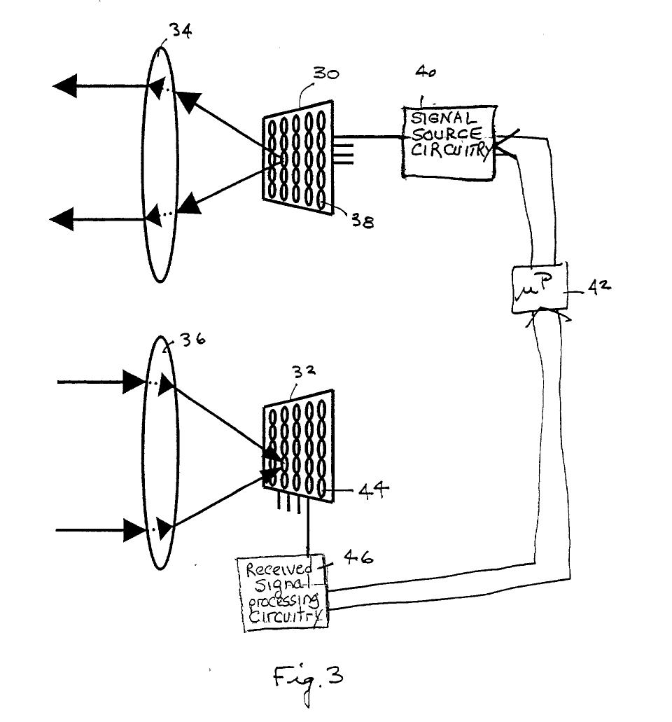

Reference is now made to FIG. 3 of the drawing, a schematic diagram primarily of the optics included at each of stations 12, 14 and 16 of network 10. The station illustrated in FIG. 3 includes transmit array 30 and receive array 32 and associated optical elements 34 and 36, illustrate as lenses. It is to be understood, however, that optical elements 34 and 36 can take other forms, for example, as disclosed in my co-pending U.S. provisional application Ser. No. 60/2799131, filed Mar. 28, 2001, entitled Spherical Antenna for Optical Communication. Transmit array 30 and receive array 32 and their associated optical elements 34 and 36 are positioned at a station so that the arrays are physically separate from each other so photonic energy emitted from transmitting array 30 does not interfere with signals arriving at detectors in receive array 32. Hence, arrays 30 and 32 can be considered as associated with separate optical antenna systems or lenses.

Transmit array 30 includes a matrix of monochromatic, preferably coherent optical emitters 38, preferably having a wavelength in the infrared region. Each of emitters 38 generates a diverging beam that is incident on lens 34. Lens 34 converts the diverging beam incident on it from emitter 38 into a beam having a beam incident on it from emitter 38 into a beam having a beam angle of approximately 2 to 3 degrees. The beam emerging from lens 34 propagates toward a receive array in an adjacent station. Each of emitters 38 is driven by a separate electrical signal source within the Signal Source Circuitry 40 so that each emitter is operated independent of signals being sent by Signal Source Circuitry to other emitters 38 in the same array 30.

Signal Source Circuitry 40 is responsive to signals derived by microprocessor 42, the signals of which are commensurate with the user data and overhead bits in a packet, as illustrated in FIG. 2 and previously described.

Signal Receive Circuitry 32 includes a rectangular matrix of optical detectors 44, preferably high sensitivity avalanche photodetectors. Optical detectors 44 are responsive to optical beams focused on them by lens 36, in turn responsive to optical beams transmitted to the station of FIG. 3 from an adjacent station in network 10. Because avalanche photodetectors have a photon sensitivity approximately two orders of magnitude greater than conventional, simple photodiodes previously employed in free space optical communication links, avalanche photodetectors are preferably employed in array 32. This is because the optical energy incident on lens 36 has a relatively wide beam width, such as 2-3 degrees, compared with a typical prior art network having beam widths of less than one degree. The wide beam width results in low photon density, requiring high sensitivity detector 44

Each of detectors 44 supplies an electric signal to Signal Receive Circuitry 46 using a separate, independent connection. When an electrical signal from detectors 44 exceeds a preset threshold level as determined by Signal Receive Circuitry's logic, 46 forms a logical connection with microprocessor 42 and communicates the signal from detector 44 to microprocessor 42, which is programmed and has memory for performing the various previously discussed processing functions. In essence, microprocessor 42 responds to the signals from Signal Receive Circuitry 46 to determine if an emitter in transmit array 30 is to be activated. If microprocessor 42 determines that an emitter in transmit array 30 is to be activated, the microprocessor selects which emitter in the transmit array is to be activated so that transmit array 30 and lens 34 direct the emitted optical energy to the receive array of an appropriate station in network 10. The selection of which emitter to use is determined as discussed herein.

Each of optical emitters 38 generates an optical beam which is incident on lens 34. The beams from different optical emitters of array 30 are directed by lens 34 to different stations 12, 14 or 16 in network 10. For each detector 44 in receive array 32 at the station illustrated in FIG. 3 there is one or more corresponding emitters, such as emitter 38, in a transmit array at another station in network 10 that couples optical energy to the station illustrated in FIG. 3. The beam associated with one detector of receive array 32 has a corresponding beam associated with and directed from a specific emitter in the transmit array of the other station in network 10. Such an arrangement allows the station of FIG. 3 to receive on a given beam and communicate with the other station of network 10.

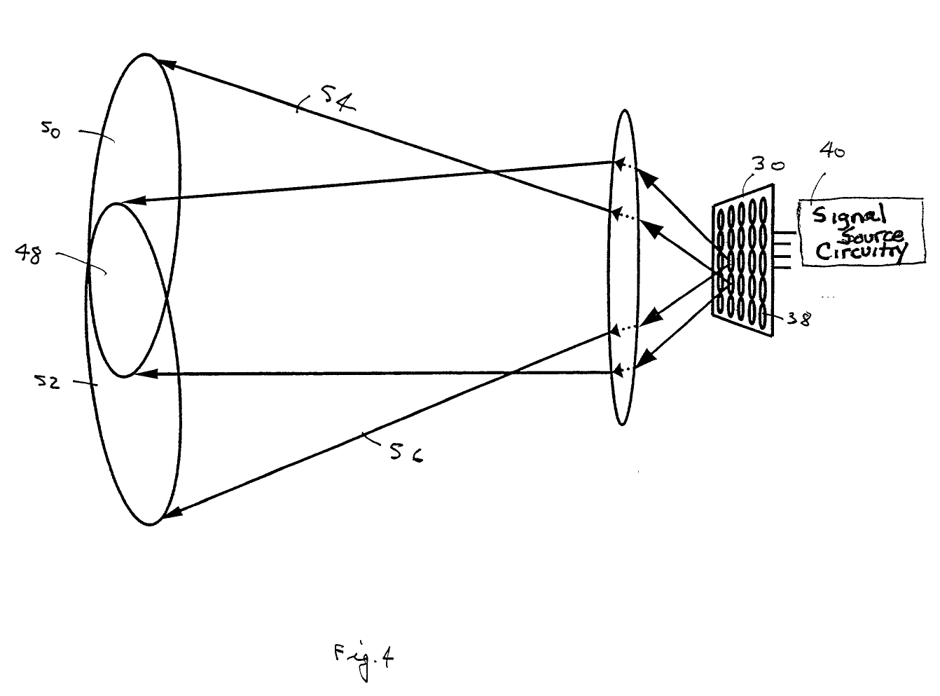

Lenses 34 and 36 are such that the beams transmitted from lens 34 as well as the beam transmitted from another station in network 10 to lens 36 are slightly divergent, having a beam width of about 2 to 3 degrees. The beams generated by different optical emitters of array 30 can also be directed by lens 34 so they overlap, when incident on a receive array, such as receive array 32, at another station in network 10. The overlapping coverage patterns are indicated by the overlapping region 48 of circles 50 and 52, FIG. 4, provided by overlapping beams 54 and 56. Overlapping region 48 provides adequate coverage or density to ensure coverage at a receive array in the event of an emitter of transmit array 30 failing or failure in the optical link between transmit array 30 and an array similar to receive array 32 at another station in network 10.

User end stations 14 and relay station 16 can include one or more of transmit array 30 and receive array 32 and associated optics, depending upon the required field of view of the particular station. Typically, base station 12 includes three or more transmit arrays and three or more receive arrays to enable the base station to have 360 degree coverage in the horizontal plane.

Detectors 44 of receive array 32 are sensitive to optical energy across a wide range of wavelengths. Optical energy incident on emitters 38 and detectors 44 can have an adverse effect on the emitters and detectors because of heating effects, particularly when solar energy is concentrated on the arrays by lenses 34 and 36. Optical energy incident on detectors 44 having a wavelength different from the wavelength transmitted between the stations of network 10 can interfere with the signals which receive array 32 desirably receives. To avoid these adverse effects, lenses 34 and 36 are coated so that they pass the wavelength of the monochromatic energy emitted by emitters 38 and block other optical wavelengths. Alternatively, a cowling or shield can be positioned in front of lenses 34 and 36 to pass the wavelength of the monochromatic energy and block other optical energy.

From the foregoing, stations of the type illustrated in FIG. 3 saturate a coverage area with multiple overlapping beams, enabling a receive beam at the station of FIG. 3 or some other station in the network constructed the same as the station of FIG. 3 to vary in arrival angles without consequence. Signals modulating the beam can move from one receive beam to another without requiring the stations to realign the beams.

While there has been described and illustrated a specific embodiment of the invention, it will be clear that variations in the details of the embodiment specifically illustrated and described may be made without departing from the true spirit and scope of the invention as defined in the appended claims.

What is claimed is:

1. A communication network comprising a plurality of optical stations adapted to be coupled to each other by free space optical links, a first as said optical stations being a base station adapted to do to be coupled to (a) stations other than said optical stations and (b) at least one of the plural optical stations, each of the plural optical stations having an identification and being arranged to couple optical messages to others of the optical stations via the optical links, each of the messages including a data portion and an identifier for a destination station of the message, each of the optical stations being arranged for (a) determining if the destination station identifier in a message matches the identification of the optical station receiving the message, and (b) responding to the data portion of the message in response to the identifier being the identification of that particular station, others of the optical stations being arranged for (a) determining if the destination station identifier in a message matches the identification of the optical station receiving the message, (b) responding to the data portion of the message in response to the identifier being the identification for that particular station, and (c) relaying the message toward the destination station in response to the identifier being different from the identification for that particular station.

2. The network of claim 1 wherein the messages are arranged in packets, each of the packets including overhead bits indicating a packet type and the destination station identifier.

3. The network of claim 2 wherein the overhead bits also indicate (a) the identification of the optical station originating the message, and (b) the type of station emitting the message.

4. The network of any of claims 1-3 wherein at least one of the plural optical stations is a relay station for (a) detecting the destination station identifier in messages that the relay station receives, and (b) relaying the message toward the destination station in response to the detected identifier, the relay station being incapable of responding to the data portion of the message.

5. The network of any of claims 1-4 wherein at least some of the plural optical stations arranged for performing (a), (b) and (c) are end user stations.

6. The network of any of claims 1-5 wherein some of the optical stations are mobile.

7. The network of any of claims 1-6 wherein each of the optical stations is arranged for transmitting each message on a monochromatic carrier having a particular wavelength, each of the optical stations including a receive array associated with or without a filter arrangement for passing the wavelength to detectors of the receive array and preventing other wavelengths from substantially affecting the detectors of the receive array.

8. The network of any of claims 1-7 wherein each of the optical stations is arranged for transmitting each message on a monochromatic carrier having a particular wavelength, each of the optical stations including a transmit array associated with a filter arrangement for (a) passing the wavelength to free space from emitters of the transmit array and (b) preventing other wavelengths from substantially affecting the emitters of the transmit array.

9. The network of any of claims 1-8 wherein each of the optical stations includes a transmit array and a receive array, the transmit and receive arrays of a particular optical station being at different locations so that photons emitted from the transmit array at the particular optical station do not interfere with signals arriving at detectors of the receive array at the particular optical station.

10. The network of any of claims 1-9 wherein each of the optical stations includes a transmitter array and a receive array, the transmit and receive arrays at any particular optical station being associated with plural beams, some of the plural beams of one optical station being arranged to be coupled with more than one of the other optical stations of the network.

11. The network of claim 10 wherein at least two of the plural beams of one optical station that are arranged to be coupled with one or more of the optical stations have overlapping beams when incident on detectors in a receiver array of an optical station coupled via one of the optical links with the optical station transmitting the overlapping beams.

12. The network of any of claims 1-11 wherein the optical stations are arranged so there are plural optical links among some of the optical stations, each of the plural optical links between some of the optical stations including different intermediate optical stations for relaying messages from an originating optical station to a designated destination optical station.

13. The network of any of claims 1-12 wherein the optical stations are arranged so each beam incident on a receiving optical station includes rays essentially parallel, each optical station including (a) an array of optical detectors arranged in detector areas and (b) an optical element for focusing each beam incident on one detector area of the receiving optical station.

14. The network of any of claims 1-13 wherein each optical station includes a transmit array of optical emitters for emitting optical beams, and an optical element for causing each emitted beam to diverge slightly as it travels through free space, the emitters and optical arrangement being arranged so that beams derived from different emitters of the same emitting array can propagate to different optical receiving stations.

15. The network of any of claims 1-14 wherein each optical station includes a receive array having many avalanche photodiodes.

16. The network of any of claims 1-15 wherein each optical station includes a transmit array including many optical emitters each having an associated beam and a receive array including many optical detector areas each having an associated beam, the beam of a detector area of a receiver optical station corresponding with the beam of an emitter of transmitter optical station.

17. An optical station for use in a communication network having a plurality of the optical stations, the optical stations being adapted to be coupled to each other by free space optical links, each of the plural optical stations having an identifier, the optical station comprising a receiver of free space optical energy messages and an emitter of free space optical energy messages, each of the messages including a data portion and an identifier for a destination station of the message, the optical station being arranged for (a) determining if the destination station identifier in a message matches the identification of the optical station, (b) responding to the data portion of the message in response to the identifier being the identification for the station, and (c) relaying the message toward the destination station in response to the identifier being different from the identification for the station.

18. The station of claim 17 wherein the messages are arranged in packets, each of the packets including overhead bits indicating a packet type and the destination station identifier.

19. The station of claim 18 wherein the overhead bits also indicate (a) the identification of the optical station originating the message and (b) the type of station emitting the message.

20. The station of any of claims 17-19 wherein the optical station is a relay station for (a) detecting if the destination station identifier in messages that the relay station receives.

21. The station of any of claims 17-19 wherein the optical station is an end user station.

22. The station of any of claims 17-19 or 21 wherein the optical station is mobile.

23. The station of any of claims 17-22 wherein the optical station is arranged for transmitting each message on a monochromatic carrier having a particular wavelength, the optical station including a receive array associated with a filter arrangement for passing the wavelength to detectors of the receive array and preventing other wavelengths from substantially affecting the detectors of the receive array.

24. The station of any of claims 17-23 wherein the optical station is arranged for transmitting each message on a monochromatic carrier having a particular wavelength, the optical station including a transmit array associated with a filter arrangement for (a) passing the wavelength to free space from emitters of the transmit array and (b) preventing other wavelengths from substantially affecting the emitters of the transmit array.

25. The station of any of claims 17-24 wherein the optical station includes a transmit array and a receive array, the transmit and receive arrays being at different locations so that photons emitted from the transmit array of the optical station do not interfere with detectors of the receive array at the station.

26. The station of any of claims 17-25 wherein the optical station includes a transmit array and a receive array, the transmit and receive arrays each being associated with plural beams, some of the plural beams being arranged to be coupled with more than one of the other optical stations of the network.

27. The station of claim 26 wherein at least two of the plural beams that are arranged to be coupled with more than one of the other optical stations of the network have overlapping portions when incident on detectors in a receiver array of another optical station of the network.

28. The station of any of claims 17-27 wherein each beam incident on the optical station includes rays that are essentially parallel, the optical station including (a) an array of optical detectors arranged in detector areas and (b) an optical arrangement for focusing each beam on one of the detector areas.

29. The station of any of claims 17-28 wherein each optical station includes a transmit array of optical emitters for emitting optical beams, and an optical arrangement for causing each beam to diverge slightly as it propagates in free space, the emitters and optical arrangement being arranged so that beams derived from different emitters of the transmit array can propagate to different optical stations of the network.

30. The station of any of claims 17-29 including a receive array having many avalanche photodiodes.

31. The station of any of claims 17-30 further including a transmit array including many optical emitters each having an associated beam, and a receive array including many optical detector areas each having an associated beam, the beam of a detector area of the station corresponding with the beam of an emitter of a transmitting optical station of the network, the transmitting optical station being different from the station of claims 17-31.

32. An optical station for use in a communication network having a plurality of optical stations, the optical stations being adapted to be coupled to each other by free space optical links, the optical station comprising a receiver of free space optical energy messages and a transmitter of free space optical energy messages, the receiver including a receive array having many optical detector element areas each having an associated beam, the transmitter including a transmit array including many optical emitter elements each having an associated beam, the beam of a detector area corresponding with the beam of an emitter element of an originating optical station of the network, an optical arrangement associated with the receive and transmit arrays, the optical arrangement and the arrays being such that beams associated with different elements of each array can be coupled with different stations of the network or can overlap when coupled with different stations of the network.

33. An optical station for use in a communication network having a plurality of optical stations, the optical stations being adapted to be coupled to each other by free space optical links, the optical station comprising a receiver of free space optical energy messages and a transmitter of free space optical energy messages, the receiver including a receive array having many optical detector element areas each having an associated beam, the transmitter including a transmit array including many optical emitter elements each having an associated beam, the beam of a detector area corresponding with the beam of an emitter element of an originating optical station of the network, an optical arrangement associated with the receive and transmit arrays, the optical arrangement and the arrays being such that beams associated with different elements of each array can be coupled with different stations of the network, the receive array including many avalanche photodiodes.

34. An optical station for use in a communication network having a plurality of optical stations, the optical stations being adapted to be coupled to each other by free space optical links, the optical station comprising a receiver of free space optical energy messages and a transmitter of free space optical energy messages, the receiver including a receive array having many optical detector element areas each having an associated beam, the transmitter including a transmit array including many optical emitter elements each having an associated beam, the beam of a detector area corresponding with the beam of an emitter element of an originating optical station of the network, an optical arrangement associated with the receive and transmit arrays, the optical arrangement and the arrays being such that beams associated with different elements of each array can be coupled with different stations of the network, the optical emitter elements emitting a monochromatic carrier having a particular wavelength, the receive array being associated with a filter arrangement for passing the wavelength to detectors of the receive array and preventing other wavelengths from substantially affecting the detectors of the receive array.

35. An optical station for use in a communication network having a plurality of optical stations, the optical stations being adapted to be coupled to each other by free space optical links, the optical station comprising a receiver of free space optical energy messages and a transmitter of free space optical energy messages, the receiver including a receive array having many optical detector element areas each having an associated beam, the transmitter including a transmit array including many optical emitter elements each having an associated beam, the beam of a detector area corresponding with the beam of an emitter element of an originating optical station of the network, an optical arrangement associated with the receive and transmit arrays, the optical arrangement and the arrays being such that beams associated with different elements of each array can be coupled with different stations of the optical emitter elements emitting a monochromatic carrier having a particular wavelength, the transmit array being associated with a filter arrangement for (a) passing the wavelength to free space from the emitters of the transmit array and (b) preventing other wavelengths from substantially as affecting the emitters of the transmit array.

36. An optical station for use in a communication network having a plurality of optical stations, the optical stations being adapted to be coupled to each other by free space optical links, the optical station comprising a receiver of free space optical energy messages and a transmitter of free space optical energy messages, the receiver including a receive array having many optical detector element areas each having an associated beam, the transmitter including a transmit array including many optical emitter elements each having an associated beam, the beam of a detector area corresponding with the beam of an emitter element of a transmitter optical station of the network, an optical arrangement associated with the receive and transmit arrays, the optical arrangement and the arrays being such that beams associated with different elements of each array can be coupled with different stations of the transmit and receive arrays being at different locations so that photons emitted from the transmit array at the station do not interfere with detectors of the receive array at the station.
